(19) United States
(12) Patent Application Publication
(10) Pub. No.: US 2014/0379168 A1
(43) Pub. Date: Dec. 25, 2014

(54) Device for the check of the validity of the insurance coverage of a means of transport and for the command of its ignition

(71) Applicant: Roberto SPADONI, (US)

(72) Inventor: Roberto Spadoni, Cenaia - Loc. Crespina (PI) (IT)

(21) Appl. No.: 14/371,490

(22) PCT Filed: Jan. 16, 2013
(86) PCT No.: PCT/IB2013/050386

§ 371 Date: Jul. 10, 2014

(30) Foreign Application Priority Data
Jan. 18, 2012 (IT) PI2012A000006

(51) Int. Cl. B60W 30/00

(52) U.S. Cl. CPC B60W 30/00; G06Q 40/08
USPC 701/1

(57) ABSTRACT

A device for commanding ignition of a motorized transport vehicle based on validity of the insurance coverage includes an electronic assembly; an external device where data on the validity of insurance coverage are memorized, the external device being connectable with the electronic assembly to transfer the insurance data. The electronic assembly (includes a processor contained in the external device, and a time device in communication with the processor and capable of reading current date and/or geographical position to block of the ignition of the vehicle if insurance coverage has expired. The processor is also programmed to compare the insurance data and the current date and/or geographical position and send a block signal of the engine if the insurance coverage is not valid. The device further includes a transceiver CAN in communication with the processor to operate the block of the engine based on reception of the block signal.

### TECHNICAL FIELD

The present invention concerns the technical field relative to command devices for handling the start-up of a wheeled motorized means of transport, for example an automobile, a scooter, a bus and similar ones.

In particular, the invention refers to an innovative device capable of verifying the validity of the insurance coverage and therefore of allowing both the start-up and also the subsequent motion of the vehicle only in case of valid insurance coverage.

### BACKGROUND ART

As it is well known, all wheeled motorized means of transport, from motorcycles to trucks and buses, must have an adequate insurance coverage to circulate. Unfortunately, road accidents are always more frequent and, many times, can also assume serious connotations. A correct insurance coverage, by law, is therefore mandatory and essential to guarantee that the person that has suffered the accident and has no fault gets compensation for damages. A missing insurance coverage implies, therefore, the impossibility to give compensation for damages to the person who has suffered the accident. It is clear that these situations can assume also very serious connotations, above all in the case in which the accident causes permanent traumas and disabilities. In these cases, it is necessary to start a long legal proceeding which, anyway, may take long to arrive at a conclusion and the results of the collection are negative many times.

In the current state of the art, checking insurance coverage is entrusted to the civil conscience of the holder of the means of transport who, before the expiration of the insurance coverage, has the obligation of renewing it and showing the related stub when requested. Although there is the risk of getting serious fines and despite the control made by law officers, there are always means of transport that circulate freely in the streets without insurance coverage.

A first solution to such a technical problem is indicated in document US2007/0046425, in which a device is described which, through a memory card, reads some data of the user and verifies if there are any irregularities. Contextually, a connection through the radio is made to a police central station and/or to an insurance center for more thorough controls and to give the consent for ignition, provided that the insurance coverage as well as the driving license turn out to be in god order. In the case of any irregularity, the start-up of the vehicle is denied.

It is clear that such a solution is not very practical since it requires a radio connection to one or more external center. Such a solution is therefore structurally complex and not very functional, since the ignition of the vehicle is linked to a response time from said centers. Moreover, if the connection via radio is accidentally interrupted, then the check turns out to be inefficient.

To solve this problem, patent application EP1415873 proposes a further solution. It foresees an alert apparatus which, through a wireless communication, reads the personal data present in an electronic driving license. Inside said apparatus there are a first and a second evaluation units suitable for verifying the validity of the driving license and the compatibility of the driver with the insurance data. The insurance data are loaded on a specific memory unit which can be internal or external to the apparatus. In an embodiment shown in FIG. 3, the memory unit 323, which contains the insurance data, is for example detachable from the apparatus. An internal clock calculates date and time and the evaluation units elaborate, through a comparison with the data coming from the time unit, the validity of the insurance coverage. The system therefore allows a verification of whether the driver is in order from the point of view of insurance and the norms to be able to guide through the extrapolation of the data from the electronic driving license and of the insurance data memorized. In the case that one or more of the data verified are not compliant (for example the insurance coverage has expired) the denial of the start of the means of transport is provided.

This solution is certainly more functional with respect to the above described prior art, since it does not require any communication via radio to external centers. The consent for the ignition of the vehicle depends on the outcome of the check of the data loaded on said memory cards, external and/or internal to the apparatus itself.

Nevertheless, document EP1415873 limits itself to denying the start-up of the means and above all does not verify the geographical position of the means. The insurance data are controlled at the moment of the startup and it is not possible to make the block of the means of transport following the consent for the ignition if, for example, during the use of the means of transport, it enters in a geographical area that is not covered by the insurance coverage or if it exceeds a certain time limit in which, effectively, the limit of validity of the insurance coverage is exceeded.

It is clear that in this case the unforeseen event of an accident would not be covered by the insurance, with possible serious consequences.

### DISCLOSURE OF INVENTION

It is therefore the aim of the present invention to provide an innovative device for the command of the startup of a motorized means of transport that solves at least in part said technical drawbacks.

It is the aim of the present invention to provide an innovative device that is capable of controlling the validity of an insurance coverage, allowing the means of transport to be put in motion only in a condition of regularity.

In particular, it is the aim of the present invention of provide an innovative device that is capable not only of denying the start-up of the means of transport in case of invalid insurance coverage, but also, and above all, of monitoring in continuous the insurance coverage validity also following the consent of put in motion and therefore during the start of the vehicle.

These and other aims are therefore reached with the present device for the control of the start-up of a motorized means of transport as described hereinafter.

The device (1) that is the object of the invention comprises:

An electronic assembly (2, 4, 5);

An external device (10) on which to electronically memorize one or more indicative data of the validity of the insurance coverage of the user, said external device being connectable in communication with the electronic assembly (2, 4, 5) for the transfer of the insurance data contained in it;

The electronic assembly (2, 4, 5) comprising a processor (2) to electronically read and process the data contained in the external device (10), and a time device (5) placed in communication with the processor (2) and capable of reading a current date and/or a geographical position in such a way as to command the block of the ignition of the means of transport in case of verification of an expired insurance coverage or anyway invalid.

In accordance with the invention, the processor (2) is further programmed to make, following the consent for the start-up of the engine, a comparison in continuous cycle between the insurance data extrapolated and the current date and/or geographical position coming from the time device (5) and updated in continuous cycle, the processor (2) sending a block signal of the engine in case of invalidity of the insurance coverage. The device (1) may include a Transceiver CAN (6) placed in communication with the processor (2) and configured to operate said block of the engine not just in the start-up phase but also during the start of the vehicle in correspondence of the reception of said block signal.

In accordance with this solution all said technical problems are solved easily.

In the first place, the put in motion of the means of transport in question is denied in case of missing insurance coverage. The circulation of means of transport lacking adequate coverage is therefore denied. In order to be able to re-activate the put in motion of the means of transport it will be necessary to proceed with the payment of the insurance coverage and thus update one's own external device of memorization of the insurance data (10).

In addition, the control at continuous cycle and the combined use of a Transceiver can 6 allows turning off the engine or block it also following the consent for the start-up.

Further advantages can also be evinced from the following description.

### BRIEF DESCRIPTION OF THE DRAWINGS

Further characteristics and advantages of the present device, according to the invention, will result clearer with the description that follows of some preferred embodiments, made to illustrate but not to limit, with reference to the annexed drawings, wherein:

FIG. 1 shows a block scheme of the device in accordance with the present invention;

FIG. 2 shows an axonometric view of the device in accordance with the invention;

FIG. 3 schematizes a possible example of device of electronic memorization of insurance data in the shape of a smart card 10.

### DESCRIPTION OF SOME PREFERRED EMBODIMENTS

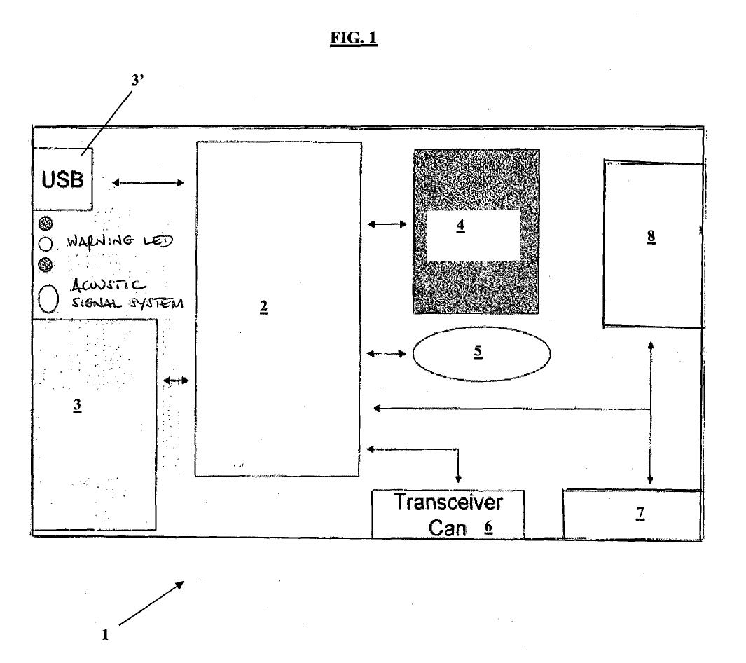

FIG. 1 describes, in accordance with a block scheme, a device 1 for the control of the start-up of a motorized means of transport, namely, a motorized transport vehicle, in accordance with the invention.

The device can be installed on any means of transport, such as an automobile, a bus or any wheeled motorized means circulating on road.

The device 1 foresees a processor 2, for example a 32-bit microprocessor of the Renesas H8SX type. The processor, as better clarified below, foresees a specific software programming that allows handling the verification of the validity of insurance coverage, as better clarified below.

With number 3 a holding seat has been indicated, into which to insert an electronic memorization device of the insurance data 10 in the shape of a smart card 10, for example.

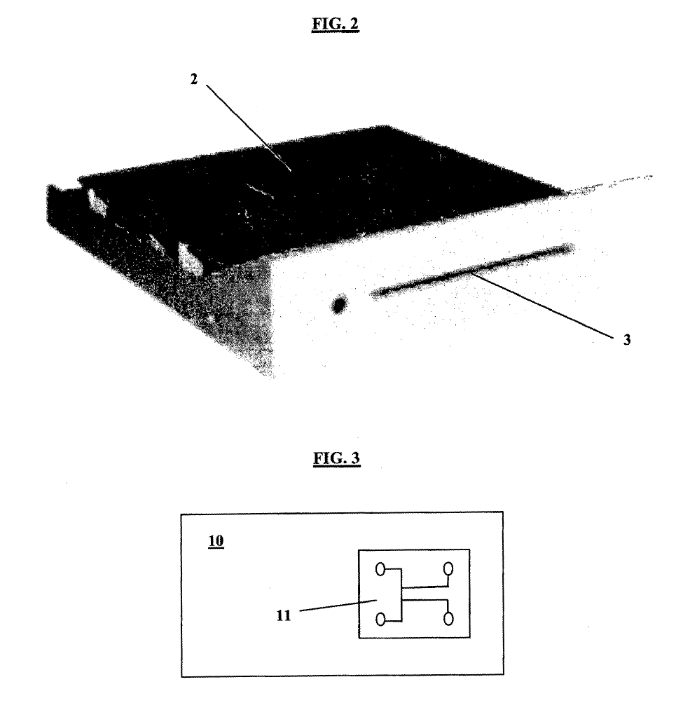

FIG. 2 shows the constructive features of what has been schematized in FIG. 1 and highlights the microprocessor and the access seat 3 for the smart card (apart from the LED of indication of the functioning status placed near the seat 3).

Going back to FIG. 1, as shown by the direction of the double arrow, once the insertion of the smart card 10 takes place there will be an electronic communication with the processor 2 so that an exchange of information can take place and in particular, the processor 2 can read the data memorized electronically in the smart card. In particular, the communication is such that the processor is capable of extrapolating the data contained in the smart card 10.

The smart card 10 is schematically represented in FIG. 3 and, as it is well known in the the art, it also comprises an electronic chip 11, into which the necessary insurance data can be loaded electronically. The smart card is well known in the state of the art and for this reason it will not be further described in detail below.

Continuing with the present structural description, the device 1 comprises an EPROM 4 card (Erasable Programmable Read Only Memory) which is in communication with the processor 2. The EPROM card is, as it is well known in the state of the art, an only reading integrative memory. In this memory card the data of the insurance coverage detected by the smart card 10 are saved and are kept. In this way, for example in the absence of the smart card, it will be anyways possible to proceed with the start of the means of transport through, for example, an ordinary keyboard since the insurance coverage data are anyway saved internally in the device.

The device foresees a time device 5 that can be, for example, in the shape of an internal clock 5, in the shape of a GPS system 5 or a combination of both. The time device 5 is therefore capable of detecting a current date (intending by current date a time, a date and a year) and/or a geographical position. The GPS system, for example, is capable of giving time, date and position.

A Transceiver CAN device 6 can be in communication with the engine to block the start-up in case of verification of an expired insurance coverage. A transceiver CAN is, therefore, a system of communication between components and specific for automobiles; it is capable of sending pre-determined commands following an input received by it.

Always as shown in the block scheme of FIG. 1, the device 1 can foresee a primary feeding 7, for example constituted by the battery itself of the vehicle. For obvious safety reasons, for example when it is necessary to make the detachment of the battery or prevent the breakage of the battery itself, a secondary feeding 8, for example, can be activated in correspondence of the de-activation of the primary feeding.

A LED lighting and an acoustic signal can be integrated in order to indicate visibly and/or with a sound notice the status detected of the insurance coverage.

As better clarified below, an input 3′ for USB key, well known in the state of the art, can be provided.

In use, therefore, the holder of the vehicle must, in order to start the ignition, insert his own smart card inside the seat 3 so that the processor 2 can read the data loaded in it.

The data of the smart card can be of different nature in order to be able to evaluate, through specific software provided in the processor, the verification of the validity of the insurance coverage.

The insurance company will be able to evaluate, in each case, the electronic loading of the validity data of the insurance in the smart card of the user every time he will have taken care of the economic situation of the insurance.

For example, in a first possible embodiment of the invention, the loading of the expiration date of the insurance coverage can be provided.

Once the smart card is inserted in its own seat 3, the processor 2 reads the data contained in it and therefore reads the expiration date of the insurance coverage.

At this point, the processor receives from the GPS 5 or from the clock 5 the current date and compares with the date memorized in the smart card. It is in fact known that a GPS is able to identify position and time through a satellite connection, and, for this reason, that aspect will not be further described in detail here.

In case the expiration date of the insurance coverage (hour/day/month/year) detected by the processor 2 through the reading of the smart card is subsequent to the current date detected by the processor through the GPS 5 or the internal clock (hour/day/month/year), then the insurance coverage will still be valid and the processor will authorize the start of the means of transport. In that sense, the processor 2 commands the transceiver can 6 to allow the ignition of the automobile.

The transceiver can 6 can act on various devices of the means of transport to allow or block the ignition exactly as in ordinary antitheft devices that are well known in the art. For example, the supply of fuel to the engine through the closing of specific valves can be blocked, or the electric feeding necessary to produce the ignition of the vehicle can be interrupted.

The data read and processed by the processor 2 are then memorized at each reading on the EPROM type card 4 in such a way that these data are not lost but are kept permanently and updated at each subsequent reading. In case of failure of the smart card the reading of the data directly from the EPROM card can be commanded and activated (in this case, for example, the expiration date of the insurance coverage) by means of a specific keyboard.

An acoustic signal and/or the LED light will be able to warn about an operating state. For example, the green light indicates that the ignition is about to happen regularly. A red light indicates that the insurance coverage has expired. A yellow light can be selected to indicate that the insurance coverage is about to expire. For example, the software of the processor can without problems be programmed in such a way that in proximity of the deadline, for example 15 days before the expiration of the insurance coverage, the start-up is allowed warning about said deadline through a specific yellow lighting and/or an acoustic signal.

The preferred embodiment of the invention foresees, as described, an inlet 3′ for a USB key.

This, as shown in the diagram of FIG. 1, can be presented as an alternative for the electronic reading of the validity data of an insurance policy (for example, through a control of the expiration date). In that case, the external data memorization device, instead of presenting itself in the form of a smart card, will have the form of a USB key.

In this case, the electronic information will be loaded in the key and will be read by the processor at the moment of its insertion in the seat 3′.

This solution can prevent the inconvenience of losing the specific smart card.

To avoid counterfeiting, both the smart card and the data contained in the key can be provided with an identification code released by the insurance company and that the processor reads and verifies before starting to make the control of the data. A 256-bit card cryptography could also be provided.

Although a receiving seat where to insert the smart card has been described, a communication between the smart card and the processor of the wireless type or of the scanning type could also be provided.

The Transceiver CAN 6 is very important because it allows a control of the engine in continuous and therefore in “real time”. The transceiver CAN 6, as indicated in FIG. 1, communicates with the processor 2 and therefore receives the information elaborated by it, apart from being in communication with the engine. If the Transceiver CAN receives a piece of information from the processor 2 that indicates an irregularity on the insurance coverage, then, as already said, it commands a block of the engine not just in the start-up phase but also following the start-up itself.

The control of the insurance data through a comparison in the processor 2 between what has been loaded by the user and the time device 5 takes place in continuous. In continuous the processor receives updated data (therefore in continuous cycle) of hour, date, year and eventually position. In this way, in continuous cycle, a control of the insurance validity is made not just at the ignition but also during the start. This gives certainty of the fact that it is possible to block the means of transport, through precisely the Transceiver Can 6, at any moment also once the vehicle has been started.

A control in continuous means a control, for example, at pre-determined intervals of time following the put in motion of the means of transport or continuously, always after the put in motion of the means of transport.

A first application example can be the following: The vehicle is started a few hours before the expiration of the insurance coverage. Formally, the internal programming of the processor authorizes the start-up of the vehicle since at start-up the comparison between the data coming from the time device 5 and those extrapolated from the smart card give a positive result. Nevertheless, the user could continue to use the vehicle beyond the time limit of the coverage. A control in continuous allows the processor 2 to receive in real time the information relative to the geographical location and/or date-hour to compare it in continuous with the insurance data extrapolated in such a way that the TRANSCEIVER CAN 6 can operate the stop of the engine following a block signal received by the processor.

In a second example, it could happen that the insurance validity is in order in temporal terms but not in territorial terms; which means that the user could go to countries where the insurance coverage is not valid. In this case, the use of a time device 5 in the form of a satellite GPS solves the problem since it also provides a geographical position. In this case, considering what has been described before, the transceiver can also operate a block of the vehicle during use if it goes beyond a territorial limit where the insurance coverage is not active.

The invention claimed is:

1. A device for commanding a start-up of a motorized transport vehicle based on validity of insurance coverage, comprising:
an electronic assembly (2, 4, 5);
an external device (10), on which to electronically memorize one or more insurance data on the validity of the insurance coverage of a user, said external device being connectable in communication with the electronic assembly (2, 4, 5) for transferring the insurance data contained in the electronic assembly;
wherein the electronic assembly (2, 4, 5) comprises a processor (2) to electronically read and process the data contained in the external device (10), and a time device (5) placed in communication with the processor (2) and configured to read one or both of a current date or a geographical position, such to command a block of the start-up of the transport vehicle in case of verification of an expired insurance coverage; and
wherein the processor (2) is further programmed to make, following consent for the start-up of an engine of the transport vehicle, a comparison in continuous cycle between the insurance data and the current date or geographical position coming from the time device (5) and updated in continuous cycle, the processor (2) sending a block signal of the engine in case of invalidity of the insurance coverage; and
a Transceiver CAN (6) placed in communication with the processor (2) and configured to operate said block of the engine at work in correspondence of reception of said block signal.

2. The device (1), as per claim 1, wherein the electronic assembly (2, 4, 5) comprises an insertion seat (3, 3′) into which to insert the external device (10) to put in said communication the electronic assembly (2, 4, 5) with said external device (10).

3. The device (1), as per claim 1, wherein the electronic assembly (2, 4, 5) and the external device (10) are configured for wireless communication between them.

4. The device (1), as per claim 1, wherein the external device (10) contains at least an expiration date of the insurance coverage so that, when the external device (10) is placed in said communication with the processor (2), the processor detects the expiration date and compares the expiration date with the data detected by the time device (5) to evaluate the validity of the insurance coverage.

5. The device (1), as per claim 1, wherein the time device is a GPS device (5).

6. The device (1), as per claim 1, wherein the time device is an internal clock.

7. The device (1), as per claim 1, wherein the electronic assembly (2, 4, 5) further comprises an EPROM card (4) in communication with the processor (2) to memorize every time the data of the external device (10) read by the processor (2).

8. The device (1), as per claim 1, wherein the external device (10) is selected from the group consisting of:
a smart card (10); or
a USB key.

9. The device (1), as claim 1, further comprising a battery of primary feeding (7) and a reserve secondary battery (8).

10. The device (1), as per claim 1, further comprising one or more of a LED lighting or an acoustic signal system to indicate current state of the insurance coverage.

11. A method for commanding a start-up of a motorized transport vehicle based on validity of insurance coverage, the method comprising the steps of:
putting in communication an external device (10), on which one or more insurance data on the validity of the insurance coverage of a user are memorized electronically, with an electronic assembly (2, 4, 5), and transferring the insurance data from the external device (10) to the electronic assembly, the electronic assembly (2, 4, 5) comprising a processor (2) configured to read electronically and process the data contained in the external device (10) and a time device (5) placed in communication with the processor (2) and configured to read one or both of a current date or a current geographical position;
comparing the insurance data with data coming from the time device (5) so as to inhibit the start-up of the transport vehicle in case of verification of an expired insurance coverage;
wherein the processor (2) makes, following consent for the start-up of an engine of the transport vehicle, a further comparison in continuous cycle between the obtained insurance data and the current date or the current geographical position coming from the time device (5) and updated in the continuous cycle; and
sending a block signal of the engine in case of invalidity of the insurance coverage, said block being operated through a Transceiver CAN (6) placed in the communication with the processor (2) and configured to operate said block of the engine at work after reception of said block signal.
